(19) United States
(12) Patent Application Publication
(10) Pub. No.: US 2013/0233099 A1
(43) Pub. Date: Sep. 12, 2013

(54) PROBE ASSEMBLY

(71) Applicant: Gunsei KIMOTO, Tokyo (JP)

(72) Inventor: Gunsei KIMOTO, Tokyo (JP)

(21) Appl. No.: 13/415,224

(22) Filed: Mar. 8, 2012

(51) Int. Cl. G01D 21/00

(52) U.S. Cl. 73/866.5

(57) ABSTRACT

Provided is a probe assembly that can be used for fine-pitch pads and can be made with lower cost. The probe assembly includes: a vertical probe which is formed by etching metal foil, and touches a to-be-inspected semiconductor chip electrode; an output terminal which projects from a side opposite to the side of the vertical probe and touches a wiring board; a thin plate-shaped probe which has a substantially rectangular cross section at a part thereof and includes an opening which engages a support rod; and a support rod which includes a first guide groove which guides the opening, a second guide groove which guides the vertical probe, and a third guide groove which guides the output terminal.

### BACKGROUND OF THE INVENTION

1. Field of the Invention

The present invention relates to a probe card of a prober unit used in a process for manufacturing electronic devices including LSI for inspecting circuits of multiple semiconductor chips that are formed on a semiconductor wafer. More particularly, the present invention relates to a probe card used in a wafer-level probing test. In the probing test, probes are made to touch circuit terminals (“pads”) arranged on the semiconductor chips to perform collective measurement of electrical conductivity of the semiconductor chips.

2. Description of Prior Art

With the advance of semiconductor technology, integration of electronic devices is increasing and the number of electrode terminals (“pads”) formed on each semiconductor chip is also increasing. Then, finer pad arrangements are becoming predominant with, for example, reduced pad areas and finer pad pitches.

Today, the LSI having the finest pitches and the largest number of electrodes is the LSI used mainly for driving liquid crystal panels (hereinafter, “LCD-driving LSI”). Pad arrangements vary in the number of electrode terminals, i.e., the number of liquid crystal pixels to be driven: in FIG. 9A, pads are arranged only on two opposite sides; in FIG. 9B, pads are arranged along the periphery; and in FIG. 9C, pads are arranged along the periphery and, on one side, two lines of pads are arranged alternately to support multi-pin arrangements.

Regarding especially the alternate pad arrangement illustrated in FIG. 9C, LSIs having pitches as fine as 15 micrometers or less between adjoining electrode pads have been developed. There is a demand to reduce inspection cost by simultaneous measuring of two to eight of these fine-pitch LSIs.

An exemplary probe card which addresses such a demand is described in Japanese Unexamined Patent Application Publication No. 2010-91541. In the described probe card, as illustrated in FIG. 10, thin plate-shaped probes 80 are arranged at fine pitches; a tip of each probe 80 is placed in each of guide holes 83 formed on a guide plate 82 in accordance with position of pads of a to-be-inspected LSI; and the guide plate 82 is fixed at a predetermined position. In this structure, tip positions of all the probes are fixed precisely.

The probe card as described in Japanese Unexamined Patent Application Publication No. 2010-91541, however, has the following problem: in an even finer (e.g., 15 micrometers or less) pad pitch structure, it is necessary to machine the guide holes on the guide plate in a finer and more precise manner; and an assembly process in which all the probe tips are made to be placed in the guide holes is very complicated, whereby the assembly cost increases. Fine-pitch structures have the following problem: it is necessary to reduce the thickness of the probe to prevent interference between adjoining probes and, as a result, deformation of the probes at vertical probe portions thereof due to buckling or twisting occurs relatively easily.

The present invention has been devised to overcome these problems and provides the following probe card used for inspection of semiconductor chips having fine-pitch pad arrangements, such as LCD-driving LSIs: the probe card is capable of touching electrode pads including continuous fine-pitch pads in a precise and reliable manner; and thereby performing electrical property inspection of all the semiconductor chips and, at the same time, providing a probe card of lower cost.

### SUMMARY OF THE INVENTION

In order to overcome the problems described above, the present invention is a probe assembly including: a vertical probe which is formed by etching metal foil, and touches a to-be-inspected semiconductor chip electrode; an output terminal which projects from a side opposite to the side of the vertical probe and touches a wiring board; and a thin plate-shaped probe which has a substantially rectangular cross section at a part thereof and includes an opening which engages a support rod, wherein the support rod includes a first guide groove which guides the opening, a second guide groove which guides the vertical probe, and a third guide groove which guides the output terminal. This structure has an effect that, since the probes constitute a probe assembly, even thin plate-shaped probes are not easily deformed due to buckling, twisting or other causes.

In an aspect of the present invention, a projection is provided on a side of the vertical probe which faces a guide groove thereof and a projection is provided on a side of the output terminal which faces a guide groove thereof; the projection of the vertical probe is placed in the guide groove thereof and the projection of the output terminal is placed in the guide groove thereof; and phase difference is provided between relative positions of the projections of adjoining vertical probes and between the relative positions of the projections of adjoining output terminals. It is therefore possible to form the guide grooves easily even in fine pitch arrangements.

In another aspect of the present invention, the Z direction length of the guide groove of the vertical probe equals to the sum total of at least a displacement amount of the vertical probe in the Z direction and the Z-direction length of the projection. It is therefore possible to easily form the guide grooves corresponding to adjoining projections.

With the structures described above, the probe card according to the present invention is, the following probe card used for inspection of semiconductor chips having fine-pitch pad arrangements, such as LCD-driving LSIs: the probe card is capable of touching electrode pads including continuous fine-pitch pads in a precise and reliable manner; and, at the same time, providing a probe card of lower cost.

### BRIEF DESCRIPTION OF THE DRAWINGS

FIG. 1 illustrates a first embodiment of the present invention.

FIG. 2 illustrates an operation of the first embodiment of the present invention.

FIGS. 3A and 3B illustrate an operation of the first embodiment of the present invention.

FIG. 4 illustrates a second embodiment of the present invention.

FIGS. 5A to 5D illustrate the second embodiment of the present invention.

FIGS. 6A and 6B illustrate the second embodiment of the present invention.

FIGS. 7A and 7B illustrate an operation of the second embodiment of the present invention.

FIGS. 8A and 8B illustrate the second embodiment of the present invention.

FIGS. 9A to 9C illustrate several kinds of pad arrangements of existing LSIs.

FIG. 10 illustrates an example of a related art probe assembly.

### DESCRIPTION OF THE PREFERRED EMBODIMENTS

### First Embodiment

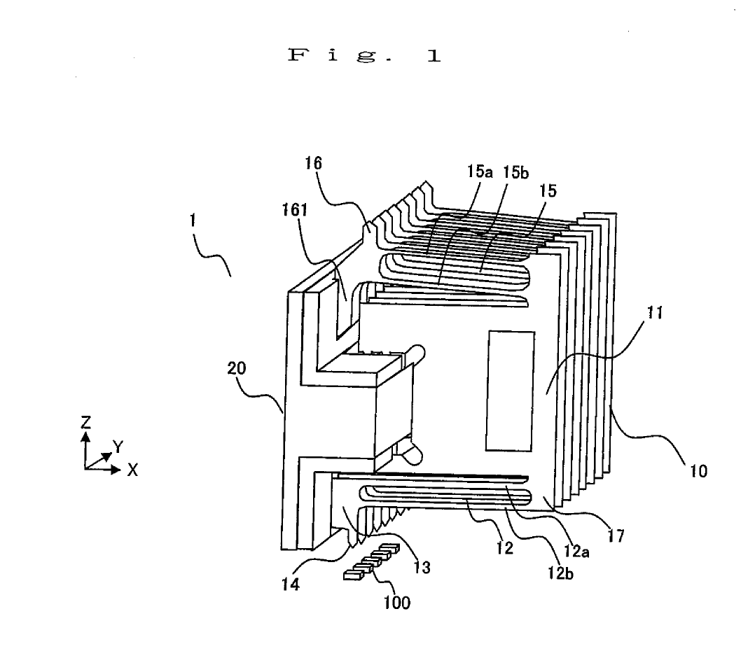

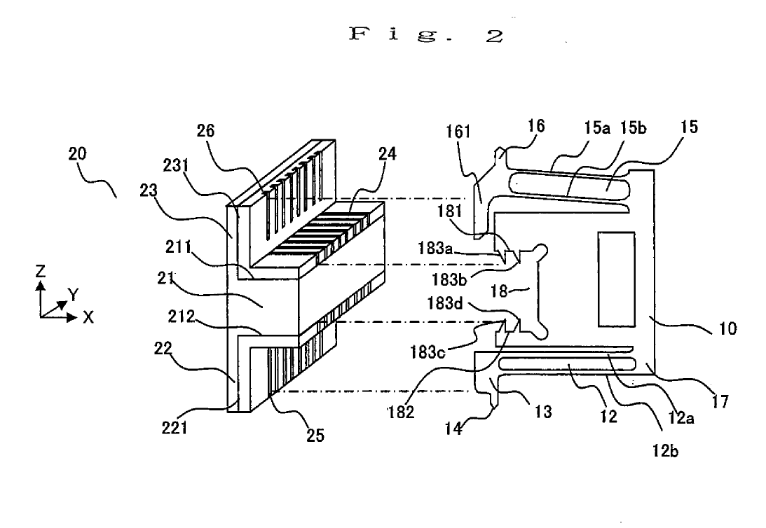

An embodiment of the present invention will be described in detail with reference to the drawings. FIG. 1 is a perspective view of a first embodiment of the present invention, illustrating an entire structure of a fine-pitch probe assembly. FIGS. 2, 3A and 3B illustrate an operation of the probe assembly.

### Probe Structure

A probe assembly 1 and thin plate-shaped probes 10 which constitute the probe assembly 1 are illustrated in FIGS. 1, 3A and 3B. Each probe 10 includes parallel spring sections 12 and 15 formed by etching metal foil 11. The parallel spring section 12 carries out a probing function. The parallel spring section 15 is formed on the side opposite to that of the parallel spring section 12. Each probe 10 includes an output terminal 16 for the output to a wiring board, and an opening 18 in which a support rod 20 which is a part of the probe assembly 1 is placed and fixed.

The parallel spring section 12, which touches an electrode pad 100 and carries out a probing function, forms a parallelogram spring constituted by a vertical probe 13, two parallel beams 12a and 12b and a fixing section 17. When the electrode pad 100 starts touching a tip 14 of the vertical probe 13 and moves in the Z direction by predetermined distance (“overdrive”) Od11 due to increased pressing force as illustrated in FIG. 3A, the vertical probe 13 produces spring force in the vertical direction (i.e., Z direction) to establish electrical conduction between the vertical probe 13 and the electrode pad 100 as illustrated in FIG. 3B.

Similarly, the output terminal 16 is a part of the parallel spring section 15 which is constituted by parallel beams 15a and 15b. Electrical conduction between the output terminal 16 and a wiring board 110 is established in the following manner: as illustrated in FIG. 3A, an amount of change Od12 is applied to the output terminal 16 to produce spring force in the Z direction when the output terminal 16 is fixed to a pad 111 of the wiring board 110; and the output terminal 16 touches the pad 111 of the wiring board 110 with reaction force of the spring. The spring load to the pad 111 of the wiring board 110 of the output terminal 16 is applied all the time after the probe assembly 1 is fixed to the wiring board 110 in the state illustrated in FIG. 3B.

### Structure of Support Rod

The support rod 20 is constituted by a first holding unit 21, a second holding unit 22 and a third holding unit 23. The first holding unit 21 has a substantially rectangular cross section and holds the probe 10. The second holding unit 22 extends in the Z direction from the first holding unit 21 along the vertical probe 13. The third holding unit 23 extends in the Z direction from the first holding unit 21 toward a tip of the output terminal 16.

### Holding Probes

First guide grooves 24 are formed at predetermined positions on side surfaces 211 and 212 of the first holding unit 21. Each first guide groove 24 guides sides 181 and 182 of the opening 18 of the probe 10 to determine the position of the probe 10. As illustrated in the drawings, the sides 181 and 182 of the opening 18 may include saw-shaped projections 183a to 183d which may engage the side surfaces 211 and 212 of the first holding unit 21 to prevent the probes 10 from being disassembled easily.

### Guiding Vertical Probe

Second guide grooves 25 are formed on a side surface 221 of the second holding unit 22 at the positions corresponding to those of the first guide grooves 24 in the Y direction. Each second guide groove 25 guides a side edge of the vertical probe 13 to determine the position of the vertical probe 13. The X direction (described below) herein corresponds to the length direction of the probe. The Y direction is perpendicular to the X direction on the same plane. The Z direction is the vertical direction which is perpendicular to both the X and Y directions.

### Guiding Output Terminal

Third guide grooves 26 are formed on a side surface 231 of the third holding unit 23 at the positions corresponding to those of the first guide grooves 24 in the Y direction. The output terminal 16 includes an extended portion 161 which extends in the Z direction. The extended portion 161 is guided by the third guide groove 26, whereby the output terminal 16 is positioned.

In the structure described above, the probes 10 are supported by and fixed to the support rod 20 and the vertical probes 13 and the output terminals 16 are guided by the guide grooves provided in the support rod 20. There is therefore an effect that the vertical probes 13 and the output terminals 16 of adjoining probes 10 are arranged at precise pitches and that even thin plate-shaped probes are not easily deformed due to buckling, twisting or other causes.

### Second Embodiment

Next, a second embodiment of the present invention will be described in detail with reference to the drawings.

### Probe Structure

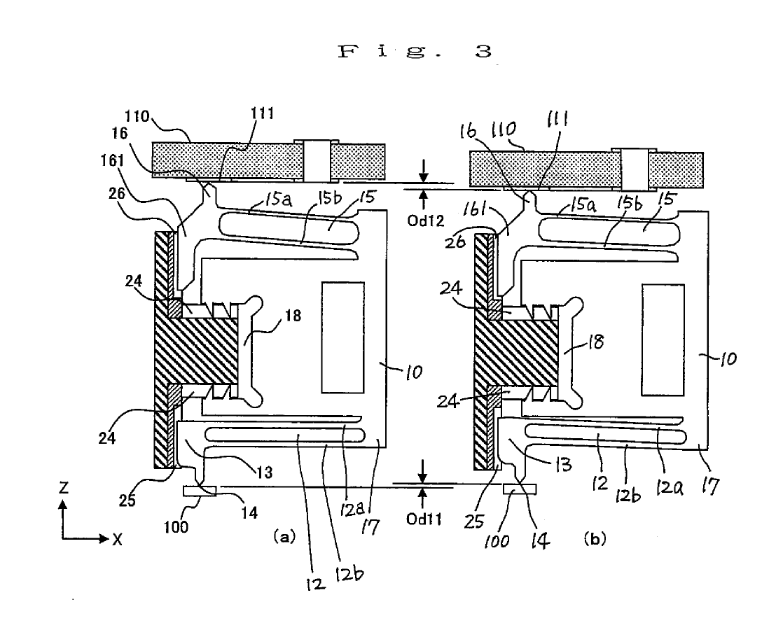

A thin plate-shaped probe 30 is illustrated in FIGS. 4 to 7B. Each probe 30 includes parallel spring sections 32 and 35 which are formed by etching metal foil 31. The parallel spring section 32 carries a probing function. The parallel spring section 35 is formed on the side opposite to that of the parallel spring section 32. Each probe 30 includes an output terminal 36 for the output to a wiring board, and an opening 38 in which a support rod 40 is placed and fixed.

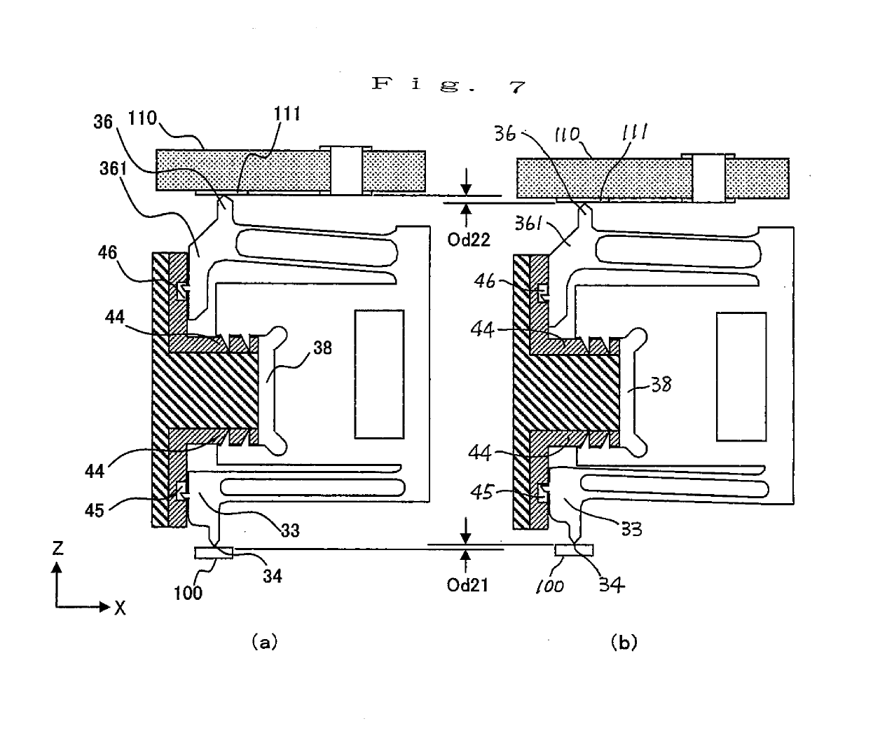

The parallel spring section 32, which touches an electrode pad 100 and carries out a probing function, forms a parallelogram spring constituted by a vertical probe 33, two parallel beams 32a and 32b and a fixing section 37. As illustrated in FIG. 7A, when the electrode pad 100 starts touching a tip 34 of the vertical probe 33, and pressing force is increased, spring force is produced in the vertical direction (i.e., Z direction) by the vertical probe 33 as illustrated in FIG. 7B, whereby electrical conduction is established between the tip 34 of the vertical probe 33 and the electrode pad 100.

Similarly, the output terminal 36 is a part of the parallel spring section 35 which is constituted by parallel beams 35a and 35b. Electrical conduction between the output terminal 36 and a wiring board 110 is established in the following manner: as illustrated in FIG. 7A, when the output terminal 36 is fixed to the wiring board 110, spring force is produced in the vertical direction (i.e., Z direction); and the output terminal 36 touches a pad 111 of the wiring board 110 with reaction force of the spring. The spring load to the pad 111 of the wiring board 110 of the output terminal 36 is applied all the time after a probe assembly 1 is fixed to the wiring board 110 in the state illustrated in FIG. 7B.

### Projections of Probe

As illustrated in the drawings, saw-shaped projections 383a to 383d are formed on sides 381 and 382 of the opening 38, and a projection 331 is formed at an edge of the vertical probe 33. The output terminal 36 includes an extended portion 361 and a projection 362. The extended portion 361 extends in the Z direction. The projection 362 is formed at an edge of the extended portion 361.

### Structure of Support Rod

The support rod 40 is constituted by a first holding unit 41, a second holding unit 42 and a third holding unit 43. The first holding unit 41 has a substantially rectangular cross section and holds the probe 30. The second holding unit 42 extends in the Z direction from the first holding unit 41 along the vertical probe 33. The third holding unit 43 extends in the Z direction from the first holding unit 41 toward a tip of the output terminal 36.

### Holding Structure of Opening

First guide grooves 44a to 44d (44c and 44d are not illustrated) are provided on side surfaces 411 and 412 of the first holding unit 41 at the position corresponding to those of the projections 383a to 383d. The first guide grooves 44a to 44d may engage the projections 383a to 383d to prevent the probes 30 from being disassembled easily.

### X-Direction Phase of Opening Projections

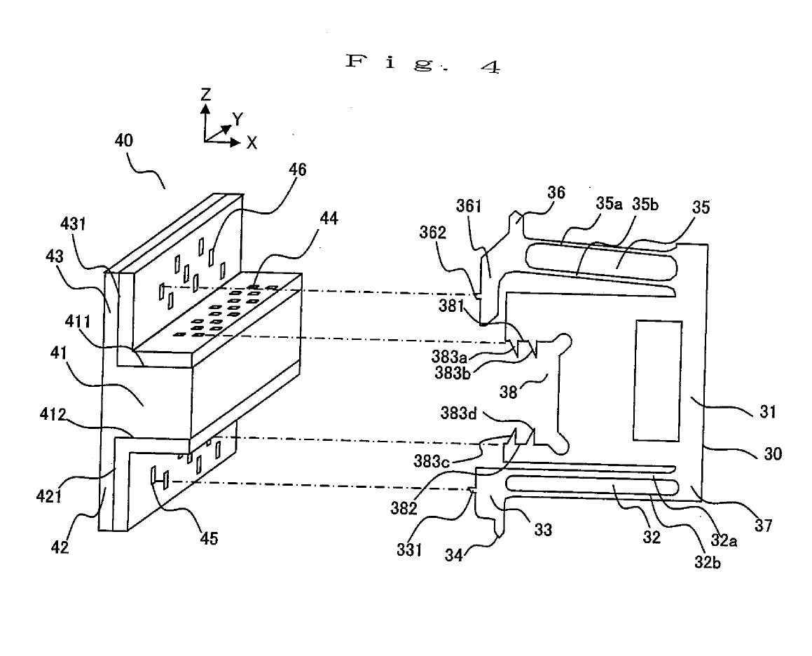

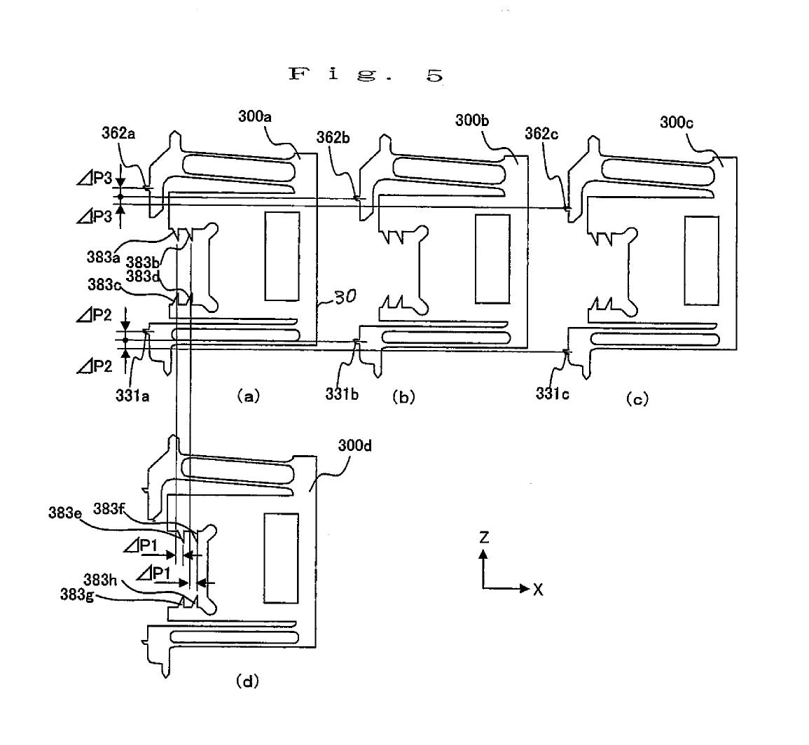

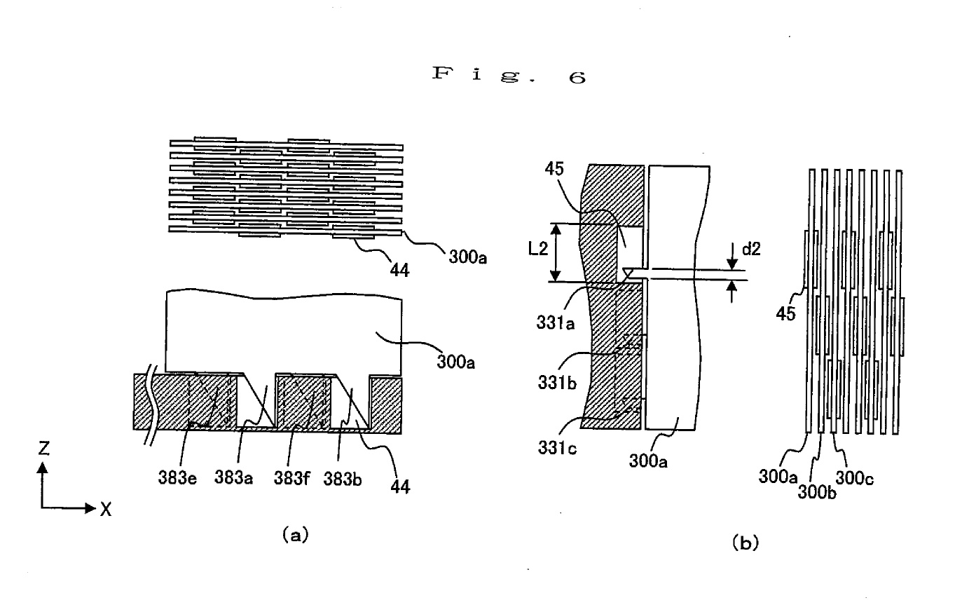

A relationship between the projections 383 of adjoining probes and the first guide grooves 44 will be illustrated in FIGS. 5A to 6B. In adjoining probes 300a and 300d, opening projections 383a to 383d of the probe 300a and opening projections 383e to 383h of the probe 300d are in a positional relationship illustrated in FIGS. 5A and 5D and having phase difference delta P1 in the X direction. Corresponding thereto, the first guide grooves are in a positional relationship illustrated in FIG. 6A. With this structure, as illustrated in FIG. 6A, it is possible to arrange adjoining probes even at fine pitches without interference between adjoining guide grooves. Since the probes illustrated in FIGS. 5A to 5D are the same in structure as the probe illustrated in FIG. 4, some reference numerals are omitted in FIGS. 5A to 5D.

### Guide Structure of Vertical Probe

As illustrated in FIG. 4, second guide grooves 45 are formed on a side surface 421 of the second holding unit 42 at positions corresponding to those of projections 331 of the vertical probes 33. The second guide grooves 45 guide the projections 331 to determine the positions of the vertical probes 33.

### Operation of Vertical Probe and Z-direction Length of Guide

Here, an operation of the probe 30 will be described with reference to FIGS. 6A to 7B. FIG. 7A illustrates a state in which the probe tip 34 has started touching the electrode pad 100 and FIG. 7B illustrates a state in which the probe tip 34 is pressed against the electrode pad 100 by a predetermined displacement amount (“overdrive”) Od21 in the Z direction. In this process, the projection 331 is also moved by the overdrive amount in the second guide groove 45. Thus, the necessary length L2 of the guide groove 45 in the Z direction is the sum total of the overdrive amount Od21 and the Z-direction length d2 of the projection 331.

### Z-direction Phase of Vertical Probe Projection

A relationship between the projections 331 of adjoining vertical probes and the second guide grooves 45 will be illustrated in FIGS. 5A to 6B. In adjoining probes 300a to 300c, a relative positional relationship among projections 331a to 331c of vertical probes of the probes 300a to 300c is illustrated in FIGS. 5A to 5C and having phase difference delta P2 in the Z direction. Corresponding thereto, the second guide grooves are in a positional relationship illustrated in FIG. 6B. With this structure, as illustrated in FIG. 6B, it is possible to arrange adjoining probes even at fine pitches without interference between adjoining guide grooves.

### Guide Structure of Output Terminal

Similarly, as illustrated in FIG. 4, third guide grooves 46 are formed on a side surface 431 of the third holding unit 43 at the same position as those of the first guide grooves 44 in the Y direction. The output terminal 36 includes an extended portion 361 which extends in the Z direction. The extended portion 361 is guided by the third guide groove 46, whereby the output terminal 36 is positioned.

### Z-Direction Phase of Projection in Output Terminal

A relationship between the projections 362 of adjoining output terminals and the third guide grooves 46 will be illustrated in FIGS. 5A to 6B. In adjoining probes 300a to 300c, a relative positional relationship among projections 362a to 362c of output terminals of the probes 300a to 300c is illustrated in FIGS. 5A to 5C and having phase difference delta P3 in the Z direction. Corresponding thereto, the third guide grooves are in a positional relationship similar to that illustrated in FIG. 6B. With this structure, as illustrated in FIG. 6B, it is possible to arrange adjoining probes even at fine pitches without interference between adjoining guide grooves.

### Operation of Output Terminal and Z-direction Length of Guide

An operation of the output terminal 36 will be described with reference to FIGS. 6A to 7B. FIG. 7A illustrates a state before the output terminal 36 touches the pad 111 of the wiring board 110 and FIG. 7B illustrates a state in which the output terminal 36 is pressed against the pad 111 in the Z direction by a predetermined displacement amount Od22. In this process, the projection 362 is also moved in the Z direction by the displacement amount Od22 in the third guide groove 46. Thus, the necessary length L3 of the guide groove 46 in the Z direction is the sum total of the Z-direction displacement amount Od22 and the Z-direction length d3 of the projection 362.

### Exemplary Method of Forming Guide Grooves

It is at least necessary that the guide grooves 44 to 46 are made of an electrically insulating material. An implementable method is to form desired guide grooves in, for example, non-conductive plastic resin and then attach the resin to the side surfaces 411, 412, 421 and 431 of the support rod 40. Another method is to apply thermosetting resin, such as silicon, or ultraviolet curing resin (hereinafter, “resin”), to the side surfaces 411, 412, 421 and 431, arrange the probes 30 in predetermined positions before the resin cures, and then let the resin cure. In this process, desired guide grooves 45 and 46 are formed by letting the projections 331 of the vertical probes 33 and the projections 362 of the output terminals 36 reciprocate in the Z direction by a necessary displacement amount at the time of curing of resin.

### Probes for Alternate Arrangements

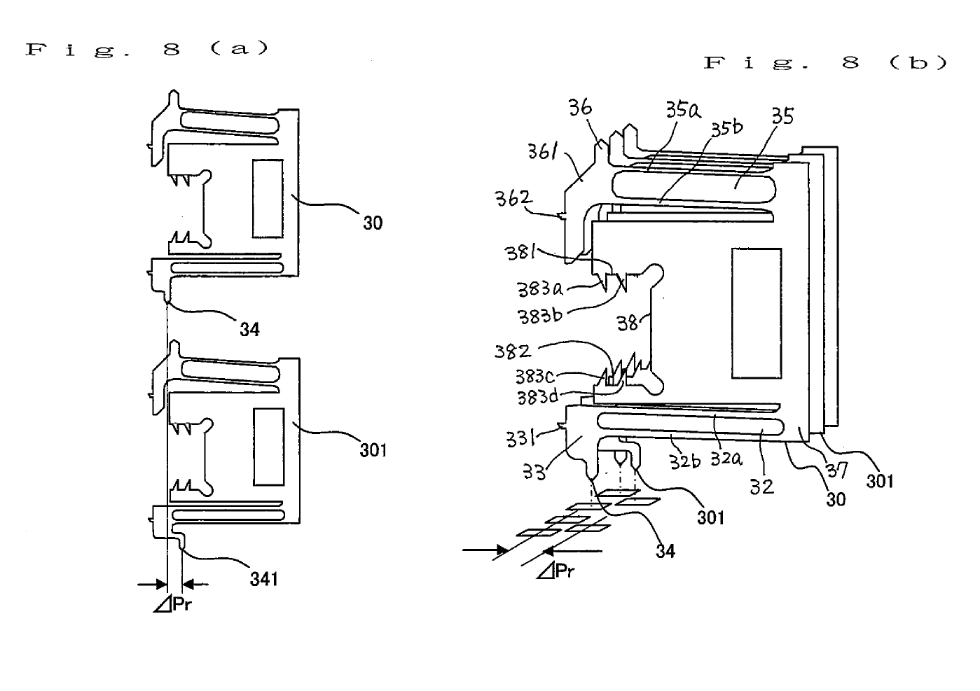

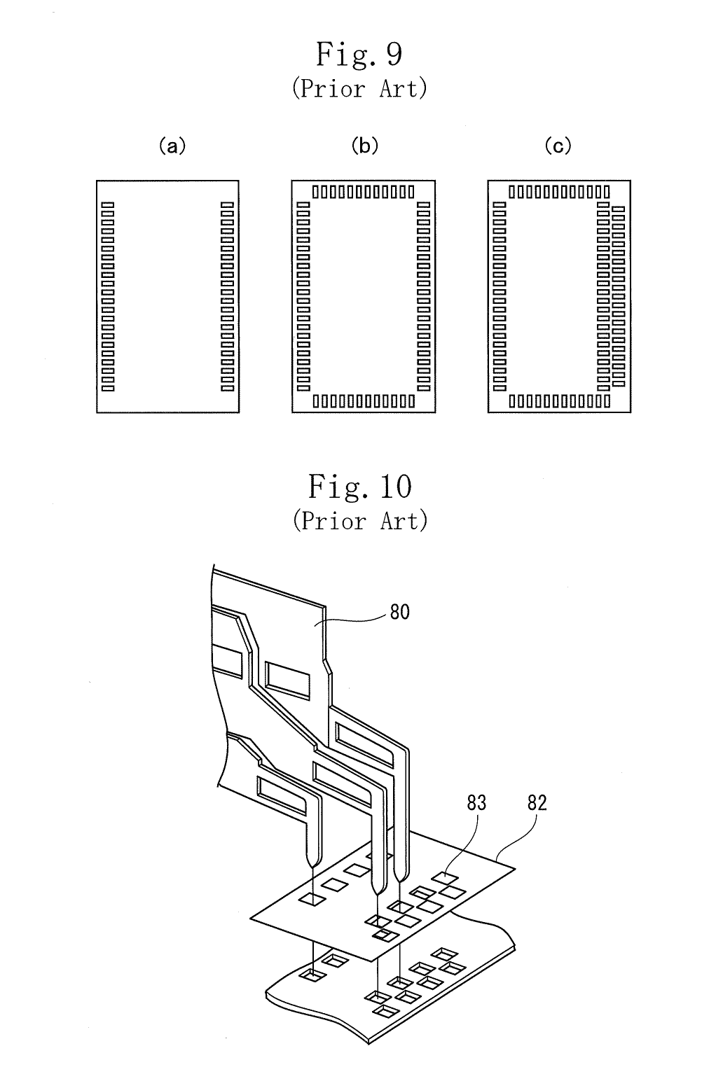

FIGS. 8A and 8B illustrates an exemplary configuration to correspond to the fine-pitch pad arrangement which includes an alternate arrangement illustrated in FIG. 9C. As illustrated in FIG. 8A, there is phase difference delta Pr between the position of a probe tip 341 of a probe 301 in the X direction and the position of the probe tip 34 of the probe 30 in the X direction. As illustrated in FIG. 8B, these probes 30 and 301 may be arranged adjacent to each other to correspond to alternate fine-pitch pad arrangements. Since the probe illustrated in FIG. 8A is the same in structure as the probe illustrated in FIG. 8B, some reference numerals are omitted in FIG. 8A.

In the structure described above, the probes 30 are supported by and fixed to the support rod 40 and, at the same time, are guided by the guide grooves formed in the support rod 40 while keeping phase difference in the Z direction between the projections 331 of adjoining vertical probes 33 and the projections 362 of adjoining output terminals 36. There is therefore an effect that the probes 30 can be arranged even at fine pitches and that even thin plate-shaped probes are not easily deformed due to buckling, twisting or other causes.

As described above, according to the present invention, in a probe card used for inspection of semiconductor chips having fine-pitch pad arrangements, such as LCD-driving LSIs, it is possible to achieve a probe card which is capable of touching electrode pads including continuous fine-pitch pads in a precise and reliable manner and, at the same time, is manufactured with lower cost.

The invention has been described with reference to the preferred embodiments illustrated in the drawings. However, it is apparent to those skilled in the art that various changes and modifications can be made without departing from the spirit and scope of the invention. The invention includes those modifications.

1. A probe assembly comprising:
a vertical probe which is formed by etching metal foil, and touches a to-be-inspected semiconductor chip electrode;
an output terminal which projects from a side opposite to the side of the vertical probe and touches a wiring board; and
a thin plate-shaped probe which has a substantially rectangular cross section at a part thereof and includes an opening which engages a support rod,
wherein the support rod includes a first guide groove which guides the opening, a second guide groove which guides the vertical probe, and a third guide groove which guides the output terminal.

2. The probe assembly according to claim 1, wherein a projection is provided in the vertical probe on a side which faces the second guide groove and the projection is placed in the second guide groove to guide the probe.

3. The probe assembly according to claim 1, wherein a projection is provided in the output terminal on a side which faces the third guide groove of the output terminal and the projection is placed in the third guide groove to guide the output terminal.

4. The probe assembly according to claim 1, wherein there are different types of probes with different relative positions in the Z direction between the projections of adjoining vertical probes or between the projections of adjoining output terminals.

5. The probe assembly according to claim 1, wherein the Z direction length of the second guide groove is the sum total of at least a displacement amount of the vertical probe in the Z direction and the Z direction length of the projection.

6. The probe assembly according to claim 1, wherein the Z direction length of the third guide groove is the sum total of at least a displacement amount of the output terminal in the Z direction and the Z direction length of the projection.

7. The probe assembly according to claim 1, wherein a saw-shaped projection is provided in the opening on a side which is placed in the first guide groove.

8. The probe assembly according to claim 1, wherein there are different types of probes with different relative positions in the X direction between the projections of the openings of adjoining probes.

9. The probe assembly according to claim 1, wherein the guide groove is made of plastic insulating resin.
